(19) United States
(12) Patent Application Publication
(10) Pub. No.: US 2015/0037110 A1
(43) Pub. Date: Feb. 5, 2015

(54) TOOL SPINDLE AND MACHINING TOOL AND METHOD FOR MACHINING WORKPIECES

(71) Applicant: MAG IAS GmbH, Goppingen (DE)

(72) Inventors: Armin WUNDERLICH, Ebersbach (DE); Holger KOLB, Ludwigsburg (DE); Heiner LANG, Esslingen (DE)

(21) Appl. No.: 14/445,742

(22) Filed: Jul. 29, 2014

(30) Foreign Application Priority Data
Jul. 31, 2013 (DE) 102013215057.1

(51) Int. Cl. B23Q 11/10; B23Q 11/00; B23Q 5/04

(52) U.S. Cl. CPC B23Q 11/1015; B23Q 5/04; B23Q 11/0003
USPC 408/1 R; 408/56

(57) ABSTRACT

A machining device has a tool spindle for machining workpieces which is connected to a first provision unit for providing a cooling fluid and to a second provision unit for providing a fluid or a lubricant-fluid mixture. The provision units are controlled by means of a control unit. Control is performed by in particular at least one measuring sensor, for instance a thermometer, by means of which a flow rate of the cooling fluid and/or the fluid or the lubricant-fluid mixture is adjusted. The tool spindle is provided with two supply channels for supplying the cooling fluid and/or the fluid or the lubricant-fluid mixture. The supply channels allow the cooling fluid and/or the fluid or the lubricant-fluid mixture to be supplied to the machining tool. This results in an optimized machining process for the most different cutting processes and materials of the workpiece.

### CROSS REFERENCES TO RELATED APPLICATIONS

This application claims the priority of Patent Application Serial No. DE 10 2013 215 057.1 filed on 31 Jul. 2013, pursuant to 35 U.S.C. 119(a)-(d), the content of which is incorporated herein by reference in its entirety as if fully set forth herein.

### FIELD OF THE INVENTION

The invention relates to a tool spindle for the machining of workpieces and to a machining tool for a tool spindle of this type. The invention further relates to a machining device comprising a tool spindle of this type as well as an associated method for the machining of workpieces.

### BACKGROUND OF THE INVENTION

WO 2010/124 045 A1 discloses a tool spindle which has an axial supply channel for the supply of a cryogenic cooling fluid to a machining tool. The supply channel is formed by a vacuum insulated pipe which is arranged stationarily and concentrically to the axis of rotation of the tool spindle. The cryogenic cooling liquid supplied via the pipe passes through a supply channel formed axially in the tool holder and the tool before reaching the tool cutting edges. Due to the fact that the cryogenic cooling fluid is supplied during machining of the workpiece, a comparatively higher machining speed is achieved for materials which are difficult to machine. The drawback of this configuration is that supplying a cryogenic cooling fluid during machining of the workpiece is not advantageous for all materials; there are some materials where the advantages achieved are so insignificant that they do not justify the additional expense.

### SUMMARY OF THE INVENTION

An object of the invention is therefore to provide a tool spindle which provides a simple and flexible way of machining workpieces for the most various cutting processes and/or materials.

This object is achieved by a tool spindle for machining workpieces, the tool spindle comprising a casing, a drive unit allowing a machining tool to be driven for rotation, and a clamping unit for clamping and releasing the machining tool, which clamping unit is arranged in the casing so as to be rotatable about an axis of rotation, and is drivable, by means of the drive unit, for rotation about the axis of rotation relative to the casing, a first supply channel for supplying a cooling fluid to the machining tool, and a second supply channel for supplying a fluid, in particular a lubricant-fluid mixture, to the machining tool. According to the invention, the tool spindle has a first supply channel for supplying a cooling fluid, and a second supply channel for supplying a fluid, in particular a lubricant-fluid mixture, to the clamped machining tool. The supply channels are configured at least partly separately from each other in the tool spindle. Preferably, the supply channels are configured entirely separately from each other in the tool spindle. The supply channels provide a simple and flexible way of supplying a cooling fluid and/or a fluid and/or a lubricant-fluid mixture to the machining tool depending on the material to be machined. In other words, the tool spindle provides for different modes of operation. The fluid is in particular a gas so that a lubricant-gas mixture is supplied.

In a first mode of operation, a cooling fluid, in particular a cryogenic cooling fluid, is supplied to the machining tool via the first supply channel, wherein no fluid, in particular no lubricant-fluid mixture, is supplied at the same time. The tool spindle is therefore operable with cryogenic cooling.

In a second mode of operation, however, a lubricant-fluid mixture is supplied to the machining tool via the second supply channel, wherein no cooling fluid is supplied at the same time. The tool spindle is thus operable with a conventional minimum quantity lubrication (MQL). The amount of the lubricant may in particular be reduced to zero so that only a fluid, in particular a gas such as air, is supplied via the second supply channel.

In a third mode of operation, a cooling fluid is supplied to the machining tool via the first supply channel while a fluid, in particular a lubricant-fluid mixture, is supplied thereto via the second supply channel at the same time. This allows high-efficiency cooling and/or lubrication to be achieved, wherein the cooling and/or lubricating properties during workpiece machining are flexibly adaptable as a function of the temperature of the cooling fluid and/or the flow rate of the cooling fluid. The cooling fluid is mixed with the fluid, in particular the lubricant-fluid mixture, either in the tool spindle or in a machining tool clamped in the tool spindle. Preferably, the amount of lubricant is reducible to zero, thus allowing a lubricant-fluid mixture or only a fluid such as air to be supplied. Mixing the cooling fluid, for instance nitrogen, with the fluid, for instance air, allows a defined cooling process to take place by means of a cold fluid, in particular cold air. If no lubricants are permitted during the machining of a workpiece, for instance when machining workpieces for aviation, electrical industry or medical technology, or if the lubricant reacts with the cutting edges or the cutting substance, for instance cubic boron nitride (CBN), a defined cooling process using cold fluid or cold air allows the workpiece machining process to be greatly improved.

If mixture takes place in the tool spindle, the supply channels either merge into each other or they open into a mixing chamber in the tool spindle. In this case, the machining tool requires only one tool supply channel in which the mixture of cooling fluid and fluid, in particular the lubricant-fluid mixture, is supplied to the distribution channels in the machining tool.

If the cooling fluid is mixed with the fluid, in particular the lubricant-fluid mixture, in the machining tool, then the supply channels are configured separately from each other up to the clamped machining tool so as to prevent the cooling fluid from mixing with the lubricant-fluid mixture in the tool spindle. If mixing takes place in the machining tool directly behind the tool spindle, then the supply channels open directly into a mixing chamber of the machining tool which forms the tool supply channel that leads to the distribution channels. If mixing does not take place directly behind the tool spindle but for instance in the center or at the end of the machining tool, then the machining tool has a first tool supply channel for the cooling fluid and a second tool supply channel for the fluid, in particular the lubricant-fluid mixture, which open into a mixing chamber which guides the mixture to the distribution channels.

The supply of the cooling fluid and/or the fluid and/or the lubricant-fluid mixture provides a simple and flexible way of optimizing workpiece machining for the most various cutting processes and materials.

A tool spindle in which the first supply channel is formed by a pipe which is arranged concentrically to the axis of rotation and is mounted in the casing for rotation about said axis of rotation provides a simple way of supplying the cooling fluid. The pipe is preferably mounted for rotation to a supply side of a connection unit, which is rigidly secured to the casing, or of a rotary feedthrough. At a discharge side, the pipe is preferably mounted in the clamping unit. Due to the fact that the pipe co-rotates with the machining tool, there is no relative rotational movement between the machining tool and the pipe. The inner space of the pipe forms the first supply channel.

A tool spindle in which the first supply channel is formed by a thermally insulating pipe provides a flexible way of supplying a cryogenic cooling fluid. The pipe in particular has a specific heat conductivity at 0° C. of no more than 0.40 W/(mK), in particular of no more than 0.30 W/(mK), in particular of no more than 0.20 W/(mK), and in particular of no more than 0.10 W/(mK). The thermally insulating design prevents an unwanted temperature increase of the cryogenic cooling fluid and an unwanted temperature decrease of the components which are in contact with the pipe. The pipe is for instance vacuum-insulated or made of a fiber composite material, in particular of a carbon fiber reinforced plastics (CFP). A pipe of a fiber composite material also has a high mechanical stability, thus ensuring high reliability and rigidity at high machining speeds. The pipe may comprise a metal sleeve, in particular a steel sleeve. The pipe is also referred to as lance.

A tool spindle in which the second supply channel is at least partly annular and surrounds the first supply channel provides a simple way of supplying the fluid, in particular the lubricant-fluid mixture. The arrangement of the supply channels ensures a compact design of the tool spindle. If the first supply channel is formed in the manner of a pipe, the wall of the pipe in particular allows a heat flow to take place if it is made of an appropriate material. The wall of the pipe therefore acts as a heat exchanger between the fluid, in particular the lubricant-fluid mixture, and the cooling fluid. As a result, an efficient cooling of the fluid, in particular the lubricant-fluid mixture, is obtained by means of the cooling fluid. The fluid, in particular the lubricant-fluid mixture, is in particular cooled before it is mixed with the cooling fluid.

A tool spindle in which an actuation rod coupled to the clamping unit has an axial bore with a bore diameter D_{B} in which a pipe having an outer diameter D_{A} is arranged, wherein D_{A}<D_{B} so that the pipe forms the first supply channel, and an annular space between the pipe and the actuation rod forms at least part of the second supply channel provides a simple way of forming an annular second supply channel. The pipe is preferably displaceable in the direction of the axis of rotation together with the actuation rod for clamping and/or releasing a machining tool. In order to clamp and/or release a machining tool, the actuation rod is preferably coupled to an actuation unit. The actuation unit is for instance configured as a pneumatic, hydraulic or electromechanical actuation unit. The actuation unit is preferably configured as a piston-cylinder unit or as a drive motor having a linear gear.

A tool spindle in which the first supply channel has a first supply opening remote from the machining tool and a first discharge opening facing the machining tool, which first supply and discharge openings are in each case arranged concentrically to the axis of rotation, provides a simple way of axially supplying and discharging the cooling fluid.

A tool spindle in which the second supply channel has a second supply opening remote from the machining tool, which second supply channel is arranged in a radial direction relative to the axis of rotation, provides a simple way of supplying the fluid, in particular the lubricant-fluid mixture, to the second supply channel, in particular if the second supply channel surrounds the first supply channel in the shape of a ring. The second supply channel is preferably provided with at least one second discharge opening which is arranged in the axial direction and/or in the radial direction relative to the axis of rotation.

A tool spindle in which a deflection member is arranged in the second supply channel which is configured in such a way that the fluid, in particular the lubricant-fluid mixture, supplied radially via the second supply opening is deflectable into the axial direction provides a simple way of reliably supplying the fluid, in particular the lubricant-fluid mixture. The deflection member causes the radially supplied fluid, in particular the lubricant-fluid mixture, to be deflected into the axial direction so that the second supply channel has a lower flow resistance. The deflection member preferably has at least one guide surface which, direction starting from the second supply opening, is curved in the axial. The deflection member is preferably drivable for rotation about the axis of rotation. To this end, the deflection member is preferably coupled to the actuation rod and/or the pipe forming the first supply channel. The rotatably drivable deflection member generates a flow of the fluid, in particular of the lubricant-fluid mixture, in the axial direction. The rotatably drivable deflection member is preferably provided with a number of guide surfaces which are arranged in a rotationally symmetric way. The guide surfaces are in particular configured in the way of turbine blades.

A tool spindle in which the supply channels open into a mixing space which is in particular formed in the region of the clamping unit provides a simple and flexible way of utilizing conventional machining tools with a single axial tool supply channel. Due to the fact that the supply channels either merge into each other or they open into a mixing chamber inside the casing, in particular in the region of the clamping unit, a mixture of the cooling fluid and the fluid, in particular the lubricant-fluid mixture, is produced in front of the machining tool, allowing the mixture to be supplied to at least one cutting edge of the tool via a tool supply channel.

Another object of the invention is to provide a machining tool for the tool spindle according to the invention which provides a simple and optimized way of flexibly machining workpieces for the most various cutting processes and/or materials.

This object is achieved by a machining tool for a tool spindle according to the invention, the machining tool comprising a clamping portion for interaction with the clamping unit, a first tool supply channel for receiving the cooling fluid from the first supply channel, a second tool supply channel for receiving the fluid, in particular the lubricant-fluid mixture, from the second supply channel, at least one cutting edge, and at least one tool discharge opening which is connected to the tool supply channels allowing the cooling fluid and/or the fluid, in particular the lubricant-fluid mixture, to be discharged in the region of the at least one cutting edge. Due to the fact that the machining tool has a first tool supply channel and a separate second tool supply channel, the cooling fluid and the fluid, in particular the lubricant-fluid mixture, may be supplied to the machining tool separately from each other. If the machining tool is clamped in the tool spindle according to the invention, the first supply channel is in connection with the first tool supply channel while the second supply channel is in connection with the second tool supply channel.

Depending on the design, the cooling fluid and the fluid, in particular the lubricant-fluid mixture, may be mixed in the machining tool before it is supplied to the at least one cutting edge, or they may be supplied to the at least one cutting edge separately from each other. In a first mode of operation of the tool spindle, only the cooling fluid, in particular a cryogenic cooling fluid, is supplied to the at least one cutting edge via the first tool supply channel. In a second mode of operation of the tool spindle, only the fluid, in particular the lubricant-fluid mixture, is supplied to the at least one cutting edge via the second tool supply channel. In a third mode of operation of the tool spindle, both the cooling fluid and the fluid, in particular the lubricant-fluid mixture, in particular a mixture of both, are supplied to the at least one cutting edge. Preferably, the second tool supply channel allows a fluid and/or a lubricant fluid mixture to be supplied. To this end, the amount of the lubricant may for instance be reduced to zero so that only the fluid is supplied. As a result, the machining tool according to the invention allows all three modes of operation of the tool spindle to be performed in a simple and reliable way. The machining tool is in particular provided with more than one cutting edge.

The machining tool according to the invention has in particular at least one temperature measuring sensor. The at least one temperature measuring sensor is preferably arranged in a tool mixing chamber into which the tool supply channels lead. The at least one temperature measuring sensor preferably allows for a wireless signal transmission to the control unit of the machining device according to the invention.

A machining tool in which the tool supply channels for mixing the cooling fluid with the fluid, in particular the lubricant-fluid mixture, open into a tool mixing chamber, and in which a number of distribution channels extend from the tool mixing chamber to a number of cutting edges provides a simple way of mixing the cooling fluid with the fluid, in particular the lubricant-fluid mixture, prior to cutting. From the tool mixing chamber, several distribution channels extend to a respective cutting edge, allowing the mixture to be supplied from the mixing chamber to the cutting edges. The mixing chamber may be formed at any position in the machining tool. The mixing chamber is preferably formed near the end of the machining tool, in other words at an end facing the tool spindle or at an end facing the workpiece to be machined. The mixing chamber is in particular formed coaxially to a tool axis of rotation.

A machining tool in which an axial bore is formed concentrically to a tool axis of rotation, wherein a tool pipe is arranged therein, provides a simple way of forming the tool supply channels. The inner space of the tool pipe forms the first tool supply channel. On the side facing the workpiece, the axial bore is preferably closed, in other words it is configured in the manner of a blind hole so that the end of the tool pipe opens into a tool mixing chamber formed by the axial bore. The tool pipe preferably has an outer diameter D_{WA} which is smaller than a bore diameter D_{WB} of the axial bore so that an annular space between the tool pipe and a base body of the machining tool forms the second tool supply channel. The tool pipe may be configured such as to correspond to the pipe of the tool spindle. The tool pipe may further be made of PTFE. The tool pipe is also referred to as tool lance.

A machining tool in which the first tool supply channel is formed by a tool pipe, and that the tool pipe at least partly defines the second tool supply channel provides a simple way of forming the tool supply channels. The first tool supply channel is formed by the inner space of the tool pipe. The second tool supply channel is preferably formed axially in the wall of the tool pipe and/or as an annular space between the tool pipe and a base body of the machining tool. Preferably, the second tool supply channel has two channel portions. In a first channel portion, a number of channels or connection channels are formed in the periphery of a wall of the tool pipe which connection channels open into a common annular channel or annular space in a second channel portion that is formed between the tool pipe and the base body of the machining tool. In the first channel portion, the channels in the tool pipe may be configured in such a way that the tool pipe entirely and/or partly forms the periphery of the channels, and that the channel is formed both by the tool pipe and by the base body and/or a sleeve. As a result, the first channel portion ensures that the tool pipe is securely mounted or fastened in the base body of the machining tool.

Another object of the invention is to provide a machining device which provides a simple and optimized way of flexibly machining workpieces for the most various cutting processes and/or materials.

This object is achieved by a machining device for machining workpieces, the machining device comprising a tool spindle according to the invention, a first provision unit for providing the cooling fluid, a second provision unit for providing the fluid, in particular the lubricant-fluid mixture, and a control unit for controlling the provision units. The cooling fluid and the fluid, in particular the lubricant-fluid mixture, are provided to the tool spindle, via the provision units. Supply of the cooling fluid and/or the fluid and/or the lubricant-fluid mixture is controlled by means of the control unit. In order to machine a workpiece, a machining tool in particular according to the invention is clamped into the tool spindle according to the invention. The machining device preferably comprises a machine tool for machining workpieces which comprises the tool spindle according to the invention. The machine tool is preferably used for shape-cutting of workpieces or materials consisting of metal and/or ceramics.

A machining device in which the first provision unit comprises a pressure storage device for the cooling fluid, which pressure storage device is in particular insulated and/or coolable, provides a simple way of supplying the cooling fluid to the tool spindle. The pressure storage device is preferably insulated and/or coolable, thus allowing cooling fluids to be provided which have a temperature T_{K} below ambient temperature. The insulated pressure storage device preferably has an outer wall which has a specific heat conductivity at 0° C. of no more than 0.40 W/(mK), in particular of no more than 0.30 W/(mK), in particular of no more than 0.20 W/(mK), and in particular of no more than 0.10 W/(mK). The pressure storage device is preferably cooled by means of a cooling assembly. The pressure storage device is in particular configured in such a way that a cooling fluid having a temperature T_{K} of no more than 0° C., in particular of no more than −10° C., and in particular of no more than −50° C. may be provided in a permanent way.

A machining device in which the first provision unit comprises a first valve for adjusting a flow rate of the cooling fluid provides a simple way of adjusting the flow rate of the cooling fluid through the tool spindle. The first valve in particular allows the flow rate of the cooling fluid to be adjusted incrementally and/or continuously. If necessary, the first valve may further be used as a stop valve which stops the supply of cooling fluid to the tool spindle. The first valve is in particular actuable by means of the control unit.

A machining device in which the second provision unit comprises a mixing device for mixing a lubricant with a fluid, which mixing device is in particular configured as a minimum quantity mixing device, provides a simple and flexible way of supplying a fluid and/or a lubricant-fluid mixture. The mixing device allows a lubricant-fluid mixture to be provided which is optimally adapted to the workpiece machining process to be performed. The lubricant is for instance solid or liquid. A solid lubricant is for instance graphite while lubricating oils may be used as liquid lubricants. The fluid is in particular provided in the form of a gas, for instance air. The mixing device is preferably configured as a minimum quantity mixing device. This allows a conventional minimum quantity lubrication to be performed. The mixing device preferably allows the amount of the lubricant to be reduced to zero, thus allowing a fluid such as air or a lubricant fluid mixture to be supplied.

The minimum quantity mixing device is in particular operable at a pressure P_{G} in the range of 1 to 12 bar above atmospheric pressure, in particular of 2 to 10 bar above atmospheric pressure, and in particular of 3 to 8 bar above atmospheric pressure. The minimum quantity mixing device is further operable at a flow rate or volumetric flow rate of the fluid of 50 to 400 l/min, in particular of 100 to 350 l/min, and in particular of 150 to 300 l/min, and at a flow rate or volumetric flow rate of the lubricant of 0 to 500 ml/h, in particular of 1 to 400 ml/h, and in particular to 5 to 300 ml/h (1 l=1 dm³=0.001 m³).

A machining device the second provision unit comprises a second valve for adjusting a flow rate of the fluid, in particular the lubricant-fluid mixture, provides a simple and flexible way of adjusting the flow rate of the fluid, in particular of the lubricant-fluid mixture. The second valve in particular allows the flow rate of the fluid, in particular the lubricant-fluid mixture, to be adjusted incrementally and/or continuously. The second valve may in particular be used as a stop valve which stops the supply of the fluid, in particular the lubricant-fluid mixture, to the tool spindle, if necessary. The second valve is in particular actuable by means of the control unit.

A machining device in which at least one measuring sensor for adjusting a flow rate of the cooling fluid and/or the fluid, in particular the lubricant-fluid mixture, ensures an optimized workpiece machining. The at least one measuring sensor allows the cooling fluid and/or the fluid and/or the lubricant-fluid mixture to be adjusted and supplied in a precise way. The machining device preferably has a first flow meter for metering the flow rate of the cooling fluid and/or a second flow meter for metering the flow rate of the fluid, in particular the lubricant-fluid mixture. The respective flow meter is preferably arranged between the associated provision unit and the tool spindle. The first flow meter and/or the second flow meter are preferably in a signal communication with the control unit, thus allowing the flow rate of the cooling fluid and/or the fluid, in particular the lubricant-fluid mixture, to be regulated by means of an associated valve. As an alternative or in addition thereto, the machining device comprises at least one thermometer which in particular allows the temperature T_{K} of the cooling fluid and/or the temperature T_{G} of the fluid, in particular the lubricant-fluid mixture, and/or a temperature T_{M} of a mixture of the cooling fluid and the fluid, in particular the lubricant-fluid mixture, to be determined. The at least one thermometer is preferably in a signal communication with the control unit, allowing the flow rate of the cooling fluid and/or the fluid and/or the lubricant-fluid mixture to be regulated by means of a valve associated thereto.

The at least one thermometer is preferably used to determine the temperature T_{G} of the fluid, in particular the lubricant-fluid mixture, and/or the temperature T_{M} of the mixture of the cooling fluid and the fluid, in particular the lubricant-fluid mixture. To this end, the at least one thermometer is in particular arranged in the region of a mixing chamber of the tool spindle and/or in the region of a tool mixing chamber of the machining tool or of the associated tool holder or clamping portion. If the at least one thermometer is arranged in the tool spindle, it is preferably arranged in the region of the clamping unit. The data or signal transmission to the control unit is wireless.

A machining device in which the control unit is configured in such a way that the following modes of operation are selectable: supplying the cooling fluid to the tool spindle without supplying the fluid, in particular the lubricant-fluid mixture, at the same time, supplying the fluid, in particular the lubricant-fluid mixture, to the tool spindle without supplying the cooling fluid at the same time, and supplying the cooling fluid and the fluid, in particular the lubricant-fluid mixture, at the same time provides a simple and flexible way of performing an optimized workpiece machining process, in particular for the most different cutting processes and/or materials. The machining device is operable in one mode of operation or in more than one mode of operation, and is thus optimally adaptable to the respective type of workpiece machining. In a first mode of operation, only a cooling fluid is supplied to the tool spindle. The cooling fluid is in particular a cryogenic cooling fluid which allows a dry workpiece machining to be performed. A suitable cryogenic cooling fluid is for instance a liquid or gaseous nitrogen which evaporates after workpiece machining. Furthermore, it is conceivable to use only air at a temperature T_{K} of no more than 0° C., in particular of no more than −10° C., and in particular of no more than −50° C. In a second mode of operation, only a fluid, in particular a lubricant-fluid mixture, is supplied. The machining device is therefore operable in a so-called minimum quantity lubrication mode. In a third mode of operation, a cooling fluid and a fluid, in particular a lubricant-fluid mixture, are supplied at the same time. It is furthermore conceivable to supply for instance cooled air at a temperature of −140° C. to 20° C. To this end, it is for instance conceivable to supply a cooling fluid or cryogenic cooling fluid and a fluid—without a lubricant—via the supply channels. As a result, the machining device is operable in a cooling and/or a lubrication mode in a simple and effective way. Depending on the type of workpiece machining, the machining device ensures optimized cooling and lubrication which are adjustable separately from each other.

Another object of the invention is to provide a method which allows workpieces to be machined simply and flexibly, wherein this machining process is optimized for the most different cutting processes and/or workpieces.

This object is achieved by a method for machining workpieces, the method comprising the following steps: providing a machining device according to the invention, the machining device comprising a machining tool clamped in the tool spindle, machining a workpiece by means of the machining tool, and simultaneously supplying a cooling fluid and a fluid, in particular a lubricant-fluid mixture, via the machining tool to at least one cutting edge of the machining tool during machining of the workpiece. Supplying a cooling fluid and a fluid, in particular a lubricant-fluid mixture, at the same time ensures optimized cooling and/or lubrication during workpiece machining, in particular because the cooling fluid can be supplied and adjusted separately from the fluid, in particular the lubricant-fluid mixture. This results in a simple and flexible way of machining workpieces which is optimized for different cutting processes and/or materials. The cooling fluid and the fluid, in particular the lubricant-fluid mixture, are supplied to the at least one cutting edge via the machining tool and can therefore be supplied to the at least one cutting edge in a precisely defined way. The machining tool is in particular configured in a way according to the invention.

A method in which the machining device is additionally operated in the following modes of operation: supplying the cooling fluid to the tool spindle without supplying the fluid, in particular the lubricant-fluid mixture, at the same time, and supplying the fluid, in particular the lubricant-fluid mixture, to the tool spindle without supplying the cooling fluid at the same time ensures an optimized workpiece machining. If, depending on the type of workpiece machining, it is required to supply only the cooling fluid or only the fluid, in particular the lubricant-fluid mixture, the machining device is operated in these modes of operation. This allows the machining process to be optimally adapted to the type of workpiece machining.

A method in which the cooling fluid and the fluid, in particular the lubricant-fluid mixture, are mixed in front of the at least one cutting edge, in particular in the machining tool or in the tool spindle allows a mixture of the cooling fluid and the fluid, in particular the lubricant-fluid mixture, to be supplied to the at least one cutting edge. Due to the fact that the cooling fluid and the fluid, in particular the lubricant-fluid mixture, are already mixed in front of the at least one cutting edge, in particular in a mixing chamber of the machining tool or in a mixing chamber of the tool spindle, a homogeneous mixture is supplied to the at least one cutting edge, thus ensuring a consistently high machining quality.

A method in which the cooling fluid, when supplied to the tool spindle, has a temperature T_{K} of no more than 10° C., in particular of no more than 0° C., in particular of no more than −10° C., and in particular of no more than −50° C. ensures a simple and effective cooling during workpiece machining. The cooling fluid is preferably a cryogenic cooling fluid which is gaseous or liquid when supplied to the tool spindle. The cryogenic cooling fluid is preferably nitrogen. The cryogenic cooling fluid in particular has a temperature T_{K} of less than −60° C., in particular of less than −120° C., in particular of less than −150° C., and in particular of less than −180° C. The cooling fluid may further have a temperature T_{K} of at least −60° C., in particular of at least −50° C., and in particular of at least −40° C. Air may for instance be supplied at a temperature T_{K} which is such that −60° C.<T_{K}<−10° C. The minimum temperature ensures that a cold cooling fluid is supplied, it is however less complicated to provide insulation in the tool spindle than to supply cryogenic cooling fluids at low temperatures T_{K}.

A method in which the cooling fluid, when supplied to the tool spindle, has a temperature T_{K} which is lower than a temperature T_{G} of the fluid, in particular the lubricant-fluid mixture, when supplied to the tool spindle provides a simple and flexible way of cooling the fluid, in particular the lubricant-fluid mixture. The mixture obtained when mixing the cooling fluid with the fluid, in particular the lubricant-fluid mixture, has a temperature T_{M} which, depending on the temperature T_{K} of the cooling fluid and on the flow rate of the cooling fluid, is lower than the temperature T_{G} of the fluid, in particular the lubricant-fluid mixture. The temperature T_{M} is simply and flexibly adjustable by means of the temperature T_{K} and/or the flow rate of the cooling fluid. If the first supply channel is formed by a pipe which is surrounded by the second supply channel in the manner of a ring, the pipe may be configured as a heat exchanger allowing the fluid, in particular the lubricant-fluid mixture, to be cooled already when supplied to the tool spindle.

A method in which a lubricant-fluid mixture is supplied to the machine tool in the form of a minimum quantity lubrication ensures an optimized workpiece machining. Depending on the type of workpiece machining, the lubricant-fluid mixture supplied contains a minimum quantity of a lubricant, thus requiring a smaller amount of the lubricant while minimizing the amount of chips to be disposed of that are contaminated with the lubricant.

Further features, advantages and details of the invention will be apparent from the ensuing description of several embodiments.

### BRIEF DESCRIPTION OF THE DRAWING

FIG. 1 shows a schematic view of a machining device for the machining of workpieces, the machining device comprising a tool spindle for the supply of a cooling fluid and a fluid, in particular a lubricant-fluid mixture, to a machining tool according to a first embodiment.

FIG. 2 shows an axial sectional view through the tool spindle and the machining tool clamped therein in FIG. 1.

FIG. 3 shows an enlarged sectional view of the tool spindle in FIG. 2 in the region of a clamping unit.

FIG. 4 shows an enlarged sectional view of the tool spindle in FIG. 2 in the region of a spindle.

FIG. 5 shows an enlarged sectional view of the tool spindle in FIG. 2 in the region of a connection unit.

FIG. 6 shows a sectional view through the connection unit along section line VI-VI in FIG. 5.

FIG. 7 shows an axial sectional view through the machining tool clamped in the tool spindle.

FIG. 8 shows an enlarged sectional view of the machining tool in FIG. 7 in the region of a clamping portion.

FIG. 9 shows a sectional view through the machining tool along section line IX-IX in FIG. 8.

FIG. 10 shows an enlarged sectional view of a machining tool according to a second embodiment in the region of a clamping portion.

FIG. 11 shows a sectional view through the machining tool along section line XI-XI in FIG. 10.

FIG. 12 shows an axial sectional view through a tool spindle and a machining tool according to a third embodiment clamped therein.

FIG. 13 shows an axial sectional view through a tool spindle and a machining tool according to a fourth embodiment clamped therein.

### DESCRIPTION OF THE PREFERRED EMBODIMENTS

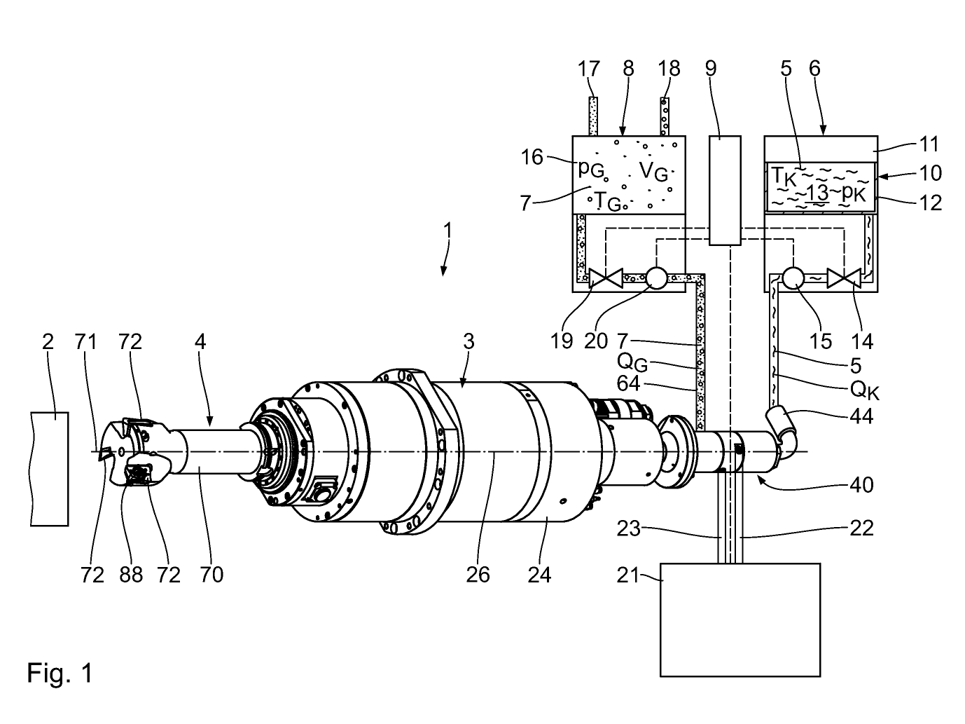

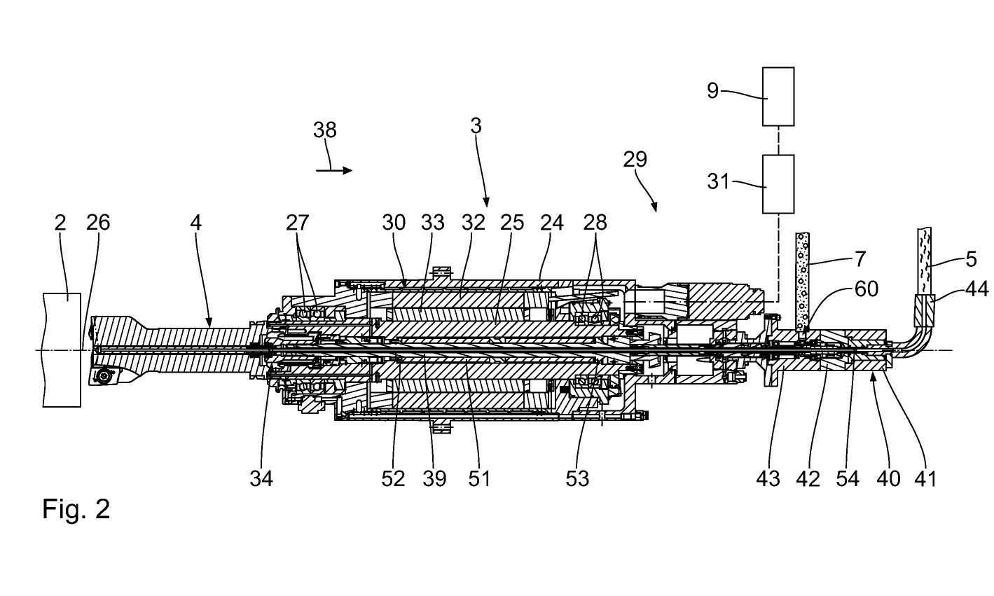

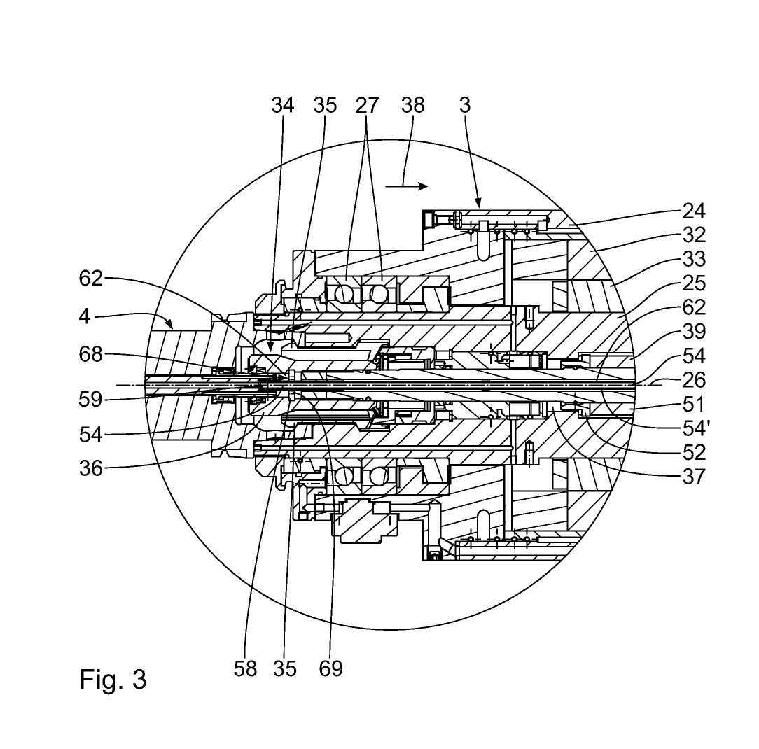

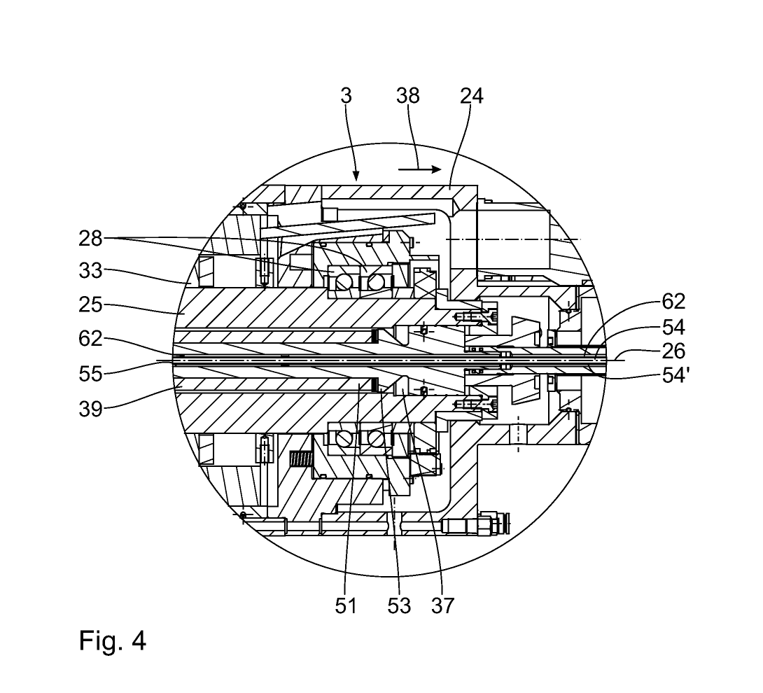

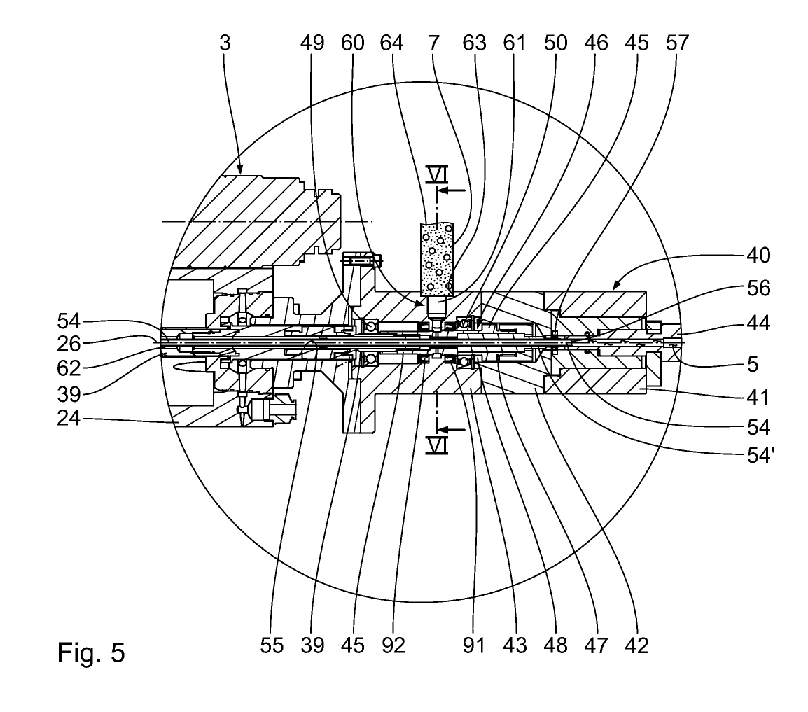

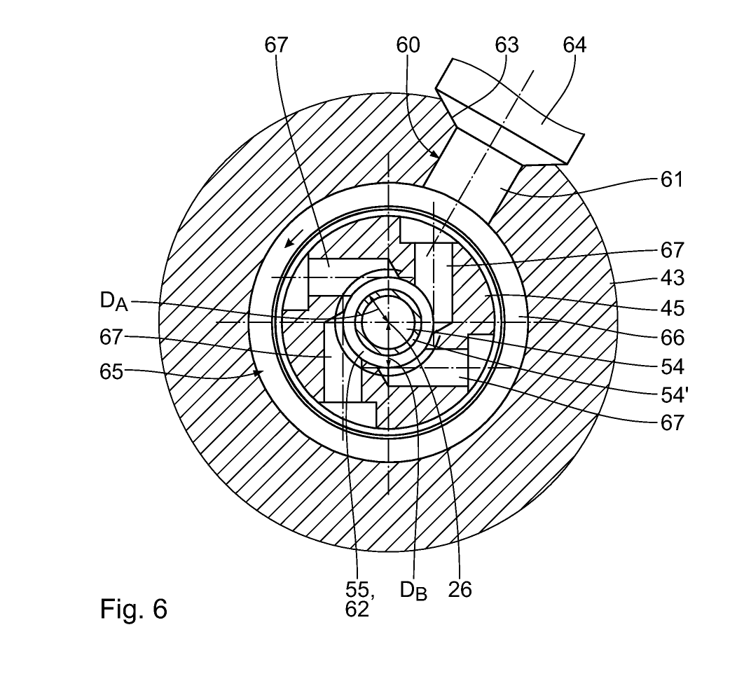

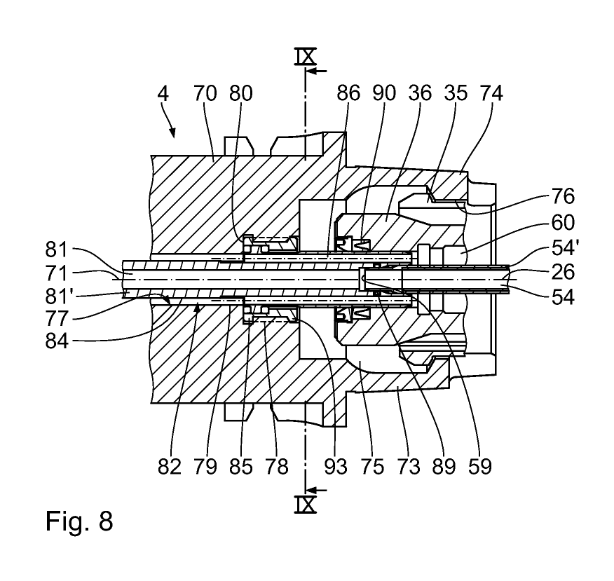

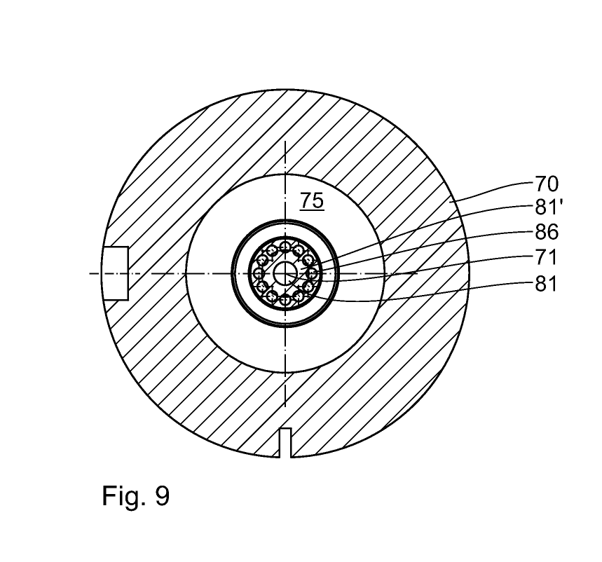

The following is a description of a first embodiment of the invention with reference to FIGS. 1 to 9. A machining device 1 is provided with a tool spindle 3 with a machining tool 4 clamped therein for chip-cutting machining of workpieces 2. The machining device 1 has a first provision unit 6 for providing a cooling fluid 5, and a second provision unit 8 for providing a fluid 18, in particular a lubricant-fluid mixture 7. The provision units 6, 8 are actuated by means of a control unit 9.

The first provision unit 6 comprises a pressure storage device 10 which is coolable by means of a cooling assembly 11. An outer wall 12 of the pressure storage device 10 is insulated so as to prevent an unwanted temperature increase of the cooling fluid 5. The cooling fluid 5 is storable in an inner space 13 of the pressure storage device 10 at a pressure p_{K} and a temperature T_{K}. The pressure p_{K} in particular amounts to at least 1.5 bar, in particular at least 3 bar, and in particular at least 5 bar above atmospheric pressure. In order for the cooling fluid 5 to be supplied to the tool spindle 3, the provision unit 6 is provided with an adjustable first valve 14 and a flow meter 15 which are in signal communication with the control unit 9. The first valve 14 therefore allows a flow rate, strictly speaking a volumetric flow rate Q_{K} of the cooling fluid, to be adjusted or regulated.

The second provision unit 8 comprises a mixing device 16 for producing the lubricant-fluid mixture 7 from a lubricant 17 and a fluid 18. The fluid 18 is in particular a gas. The mixing device 16 is in particular operable as a minimum quantity mixing device 16 in order to perform a minimum quantity lubrication. The mixing device 16 is in particular operable in such a way that the amount of the lubricant 17 is reducible to zero so that only the fluid 18 is supplied. The fluid 18 is in particular a gas such as air. The second provision unit 8 further comprises an adjustable second valve 19 and a second flow meter 20 which are in signal communication with the control unit 9. The mixing device 16 allows the fluid 18, in particular the lubricant-fluid mixture 7, to be provided at a pressure p_{G}, a temperature T_{G} and in a mixing ratio V_{G}. A flow rate or volumetric flow rate Q_{G} of the fluid 18, in particular the lubricant-fluid mixture 7, is adjustable or regulable by means of the valve 19.

The machining device 1 is part of a machine tool not shown in more detail for the machining of workpieces 2 made of metal. To this end, the control unit 9 is configured in such a way that the following modes of operation are selectable:
a) supplying the cooling liquid 5 to the tool spindle without supplying the fluid 18 or the lubricant-fluid mixture 7 at the same time;
b) supplying the fluid 18, in particular the lubricant-fluid mixture 7, in particular for minimum quantity lubrication, to the tool spindle 3 without supplying the cooling fluid 5 at the same time; and
c) supplying the cooling fluid 5 and the fluid 18, in particular the lubricant-fluid mixture 7, to the tool spindle 3 at the same time.

The flow rates or volumetric flow rates Q_{K} and Q_{G}, respectively, are adjustable according to requirements by means of the control unit 9, the valves 14, 19 and the associated flow meters 15, 20. This provides a simple and flexible way of performing an optimized workpiece machining with respect to the cutting process to be performed and/or the material to be cut.

The machining device 1 comprises an actuation unit 21 for clamping and releasing a machining tool 4. The actuation unit is for instance configured as a hydraulic actuation unit and is hereinafter also referred to as hydraulic unit 21. The hydraulic unit 21 is connected to the tool spindle 2 via two pressures lines 22, 23 allowing the machining tool 4 to be released or clamped by applying a pressure to the pressure pipe 22 or 23. The actuation unit 21 is in signal communication with the control unit 9 for clamping and releasing the respective machining tool 4.

The tool spindle 3 has a casing 24 in which a spindle 25 is mounted in the usual way via bearings 27, 28 for rotation about an axis of rotation 26. The machining device 1 has a drive unit 29 comprising a drive motor 30 and a drive electronics 31 associated thereto allowing the machining tool 4 to be driven for rotation. The drive motor comprises a stator 32 which is rigidly connected to the casing 24, and an associated rotor 33 which is rigidly connected to the spindle 25 so as to drive the latter for rotation about the axis of rotation 26. The drive electronics 31 ensures that the drive motor 30 is supplied with energy and is in signal communication with the control unit 9 for actuation of the drive motor 30.

The tool spindle 3 has a clamping unit 34 for clamping and releasing a machining tool 4. The clamping unit 34 comprises a number of clamping chucks 35 and an associated clamping cone 36. The clamping unit 34 is arranged in a bore 37 of the spindle 25 which is arranged concentrically to the axis of rotation. The clamping chucks 35 are arranged in the bore 37 in such a way as to be distributed around the axis of rotation 26 and are mounted to the spindle 25 in such a way as to be pivotable in a radial direction. The clamping cone 36 is arranged concentrically to the axis of rotation 26 and is surrounded by the clamping chucks 35. The clamping chucks 35 are spread open in the radial direction by axially displacing the clamping cone 36 in a clamping direction 38 while the clamping chucks 35 are movable to a non-spread state of release by displacing the clamping cone 36 in a direction opposite to the clamping direction 38.

The clamping cone 36 is connected to an actuation rod 39 for axial displacement thereof. The actuation rod 39 is arranged concentrically to the axis of rotation 26 and extends through the bore 37 up to an end of the casing 24 remote from the clamping unit 34. In order to generate a clamping force, at least one spring member 51 is provided which is arranged in the bore 37 between a spindle stop 52 and an actuation rod stop 53. The at least one spring member 51 is preferably configured as a disc spring package which is arranged concentrically to the axis of rotation 26 and surrounds the actuation rod 39.

At the end of the casing 24 remote from the clamping unit 34, a connection unit 40 is secured to the casing 24 in such a way as to be concentric to the axis of rotation 26. The connection unit 40 has a first connection portion 41 for the cooling fluid 5, a second connection portion 42 for the hydraulic unit 21 and a third connection portion 43 for the fluid 18 or the lubricant-fluid mixture 7.

The cooling fluid 5 is supplied via the first connection portion 7. To this end, a first supply pipe 44 is detachably secured to the first connection portion 41 in such a way as to be concentric to the axis of rotation 26. The pressure lines 22, 23 of the hydraulic unit 21 are connected to the second connection portion 42. In the second connection portion 42, an axially displaceable piston 45 is arranged such that the piston 45 forms a piston cylinder unit with the second connection portion 42. The piston 45 divides an inner cylinder space 46 formed by the second connection portion 42 into two partial spaces 47, 48. Each of the pressure lines 22, 23 opens into a respective one of the partial spaces 47, 48. The inner cylinder space 46 is sealed in the usual way. The piston 45 passes through the third connection portion 43 and is connected, via an end portion thereof, to the actuation rod 39. The actuation rod 39 and the piston 45 connected therewith are mounted for rotation in the third connection portion 43 by means of bearings 49, 50. Via the third connection portion 43, the connection unit 40 is rigidly connected to the casing 24. The connection unit 40 is also referred to as rotary feedthrough.

A first supply channel 54 is formed in the tool spindle 3 in order to supply the cooling fluid 5 to the machining tool 4. The first supply channel 54 is formed by a pipe 54′. The pipe 54′ is arranged concentrically to the axis of rotation 26 and extends from the connection unit 40 to the clamping unit 34. To this end, an axial bore 55 is formed in the piston 45 and the actuation rod 39 in which the pipe 54′ is arranged. The pipe 54′ is axially and radially secured to the actuation rod 39, allowing the pipe 54′ to be drivable for rotation together with the spindle 25 and the actuation rod 39 while being axially displaceable together with the actuation rod 39 when the machining tool 4 is replaced. The pipe 54′ is thus mounted for rotation about the axis of rotation 26 relative to the casing 24.

The pipe 54′ is configured in such a way as to be thermally insulating. To this end, the pipe 54′ has a specific heat conductivity at 0° C. of no more than 0.80 W/(mK), in particular of no more than 0.40 W/(mK), in particular of no more than 0.30 W/(mK), in particular of no more than 0.20 W/(mK), an in particular of no more than 0.10 W/(mK).

The pipe 54′ is for instance configured as a vacuum insulated pipe. To this end, the pipe 54′ has an inner pipe and an outer pipe surrounding said inner pipe, wherein the lines are interconnected at their ends. The insulation space defined by the pipes is evacuated; as a result, the pipe 54′ has an extremely low specific heat conductivity. In order to compensate for the different linear expansions of the inner and the outer pipe caused by the cooling fluid 5, the inner pipe and/or the outer pipe are length-adjustable. If for instance a cryogenic cooling fluid 5 flows through the pipe 54′, the temperature of the inner pipe decreases until it is equal to the temperature of the cryogenic cooling fluid 5 while the temperature of the outer pipe decreases to a much lesser extent because of the insulation medium arranged therebetween. Therefore, the length of the inner pipe increases to a much greater extent than that of the outer pipe. In order to prevent the pipe 54′ from being damaged, at least one of the lines is length-adjustable. The outer pipe is preferably provided with a meander-shaped metal bellows allowing a thermal linear expansion to take place. The pipe 54′ is further made of for example a fiber composite material, in particular a carbon fiber reinforced plastics (CFP).

When the supply pipe 44 is connected, the supply end of the pipe 54′ is inserted therein. A first supply opening 56 of the first supply channel 54 or the pipe 54′ is therefore arranged concentrically to the axis of rotation 26. The pipe 54′ is sealed relative to the first connection portion 41 by means of an annular sealing member 57. The sealing member 57 is for instance made of PTFE (polytetrafluoroethylene). At a discharge end, the pipe 54′ is mounted in the clamping cone 36 by means of a bearing member 58 in such a way as to be concentric to the axis of rotation 26. A first discharge opening 59 of the first supply channel 54 or the pipe 54′ is therefore arranged concentrically to the axis of rotation 26. The end of the pipe 54′ is arranged in the clamping cone 36.

In order to supply the fluid 18 or the lubricant-fluid mixture 7 to the machining tool 4, the tool spindle 3 is further provided with a second supply channel. The second supply channel 60 comprises a first channel portion 61 which extends radially to the axis of rotation 26, and a second channel portion 62 which extends concentrically to the axis of rotation 26. The first channel portion 61 is formed in the third connection portion 43 and extends in the radial direction up to the axial bore 55. In other words, the first channel portion 61 forms a second supply opening 63 remote from the machining tool 4 which is arranged in a radial direction relative to the axis of rotation 26. The second supply opening 63 is provided with a second supply pipe 64 which allows the fluid 18 or the lubricant-fluid mixture 7 to be supplied.

In order to seal the first channel portion 61, two annular sealing members 91, 92 are arranged on both sides thereof when seen in the axial direction which abut against the piston 45 and the third connection portion 43. The sealing members 91, 92 are arranged between the bearings 49, 50. The sealing members 91, 92 are for instance made of PTFE. The first channel portion 61 opens into the second channel portion 62 via a deflection portion 65.

The deflection portion 65 comprises an annular space 66 into which the first channel portion 61 opens and in which a part of the piston 45 is arranged concentrically to the axis of rotation 26. The rotatably drivable piston 45 is configured as a deflection member in the region of the annular space 66 allowing the fluid 18 or the lubricant-fluid mixture 7, which is in each case supplied radially via the second supply opening 63, to be deflected into the axial direction. To this end, the piston 45 is provided with a number of, for instance four, guide channel portions 67 which are rotationally symmetric to the axis of rotation 26. The guide channel portions 67 are in each case provided with at least one guide surface which is curved to such an extent that the fluid 18 or the lubricant-fluid mixture 7 is deflected from the radial direction of the first channel portion 61 into the axial direction of the second channel portion 62 so as to be conveyed in the direction of the machining tool 4. The guide surfaces are preferably configured in the manner of turbine blades.

The guide channel portions 67 open into the second channel portion 62. The second channel portion 62 is annular so as to surround the first supply channel 54 or the pipe 54′. The second channel portion 62 is therefore on one side bounded by the pipe 54′ and by the piston 45, the actuation rod 39 and the clamping cone 36 on the other. The second channel portion 62 is in other words configured as an annular space. The annular space has a radial dimension which is defined by an outer diameter D_{A}, the pipe 54′ and a respective bore diameter D_{B} of the axial bore 55.

The second supply channel 60 has a second discharge opening 68 which is arranged in the region of the clamping cone 36. The second discharge opening 68 is annular and is bounded by the pipe 54′ and the clamping cone 36 in the radial direction. The bearing member 58 is provided with a number of breakthroughs 69 allowing the fluid 18 or the lubricant-fluid mixture 7 to be guided therethrough. As a result, the supply channels 54 and 60 are configured as separate entities along their entire length, thus preventing the cooling fluid 5 and the fluid 18, in particular the lubricant-fluid mixture 7, from mixing in the tool spindle 3 when supplied at the same time.

The machining tool 4 has a base body 70 which is drivable, by means of the tool spindle, for rotation about a tool axis of rotation 71. When the machining tool 4 is clamped, the tool axis of rotation 71 is in line with the axis of rotation 26. At an end of the machining tool 4 near the workpiece, a number of cutting edges 72 are secured to the base body 70 which are distributed around the tool axis of rotation 71 in a rotationally symmetric way.

The base body 70 is provided with a clamping portion 73 allowing the machining tool 4 to be clamped therein. In the clamping portion 73, the base body 70 has an annular shape and is provided with an annular retaining protrusion 74 disposed at an end facing the tool spindle 3. The clamping portion 73 defines a receiving space 75 which is provided with an opening 76 facing the tool spindle 3. The opening 76 is bounded by the retaining protrusion 74 in the radial direction. The function of the opening 76 and the associated receiving space 75 is to insert and receive the clamping unit 34.

Starting from the receiving space 75, an axial bore 77 extends concentrically to the axis of rotation 71 up to the end of the base body 70 near the workpiece. The axial bore 77 is configured as a blind hole, in other words it does not pass through the base body 70 at the near-workpiece end. Adjacent to the receiving space 75, the axial bore 77 has a first bore portion 78 with a bore diameter D_{WB1} and a subsequent second bore portion with a second bore diameter D_{WB2} The first bore diameter D_{WB1} is greater than the second bore diameter D_{WB2} so that the bore portions 78, 79 form an annular stop 80.

In the axial bore 77, a first tool supply channel 81 is formed for receiving the cooling fluid 5 from the first supply channel 54, and a second tool supply channel 82 is provided for receiving the fluid 18 or the lubricant-fluid mixture 7 form the second supply channel 60. To this end, the first tool supply channel 81 is formed by a tool pipe 81′. The tool pipe 81′ is also referred to as tool lance. The tool pipe 81′ is for instance made of a carbon fiber reinforced plastics (CFP) or of PTFE.

The tool pipe 81′ is secured in the axial direction by means of a fastening member 93. The fastening member 93 is arranged in the first bore portion 78. The fastening member 93 is for instance configured as a fastening nut which forms a screw connection with the base body 70.

Starting from the receiving space 75, the tool pipe 81′ extends up to a tool mixing chamber 83 which is formed at the end of the axial bore 77 near the workpiece. The tool pipe 81′ is arranged concentrically to the axis of rotation 71 and has an outer diameter D_{WA} which, in the region of the second bore portion 79, is smaller than the bore diameter D_{WB2} so that the tool pipe 81′ and the base body 70 together form an annular space 84. In the region of the first bore portion 78 and in the receiving space 75, the second bore portion 79 has a wall thickness which is greater than that of the second bore portion 79 so that the tool pipe 81′ forms a counter stop 85 for the annular stop 80. In addition thereto, a number of connection channels 86 are formed at the end of the tool pipe 81′ facing the tool spindle 3 which extend in the axial direction from the free front end up to the annular space 84. The connection channels 86 and the annular space 84 together form the second tool supply channel 82.

Distribution channels 87 extend from the mixing chamber 83 to the cutting edges 72. Each of the distribution channels 87 is provided with a tool discharge opening 88 via which the cooling fluid 5 and/or the fluid 18 and/or the lubricant-fluid mixture 7 may exit the machining tool 4 in the region of the cutting edges 72. The tool supply channels 81, 82 open into the mixing chamber 83 in order to produce a mixture of the cooling fluid 5 and the fluid 18, in particular the lubricant-fluid mixture 7.

In the mixing chamber 83, a thermometer 100 is arranged. The thermometer 100 allows a temperature T_{M} of a mixture of the cooling fluid 5 and the fluid 18, in particular the lubricant-fluid mixture 7, to be measured and transmitted to the control unit 9 via a wireless connection. The thermometer 100 allows the flow rate Q_{K} of the cooling fluid 5 and/or the flow rate Q_{G} of the fluid 18, in particular the lubricant-fluid mixture 7, to be adjusted.

The tool pipe 81′ is configured in such a way that when the machining tool 4 is clamped, the pipe 54′ is inserted into the tool pipe 81′. An annular sealing member 89 is arranged at an inner wall of the tool pipe 81′ in order to seal the pipes 54′, 81′. The sealing member 89 is for instance made of PTFE. The tool pipe 81′ is further configured in such a way as to be insertable into the clamping cone 36. When the machining tool 4 is clamped, the wall of the tool pipe 81′ is therefore arranged in the annular space between the pipe 54′ and the clamping cone 36 so that the supply channels 54′ and 81′ as well as 60 and 82 are interconnected. In order to seal the supply channels 60 and 82, an inner wall of the clamping cone 36 is provided with an annular sealing member 90. The sealing member 90 is for instance made of PTFE.

The mode of operation of the machining device 1 is as follows:
In order to clamp a machining tool 4, the clamping unit 34 is at first actuated so as move to an open position. To this end, the pressure pipe 22 is pressurized via the hydraulic unit 21, causing the partial space 47 to be filled with a pressure medium so that the piston 45 is displaced axially in a direction opposite to the clamping direction 38. Via the actuation rod 39, the axial movement of the piston 45 is transferred to the clamping cone 36, causing the clamping cone 36 to be moved away from the clamping chucks 35 so that the clamping chucks 35 are released. The pipe 54′ is axially displaced together with the actuation rod 39. The actuation rod 39 is axially displaced in a direction opposite to the biasing force of the at least one spring member 51.

Afterwards a machining tool 4 is clamped into the tool spindle 3 in the usual way. To this end, the machining tool 4 is moved in the axial direction relative to the clamping unit 34, for instance using a conventional tool changer, causing the clamping chucks 35 and the clamping cone 36 to be arranged near the end of the receiving space 75. When this happens, the wall of the tool pipe 81′ is introduced into the annular space between the pipe 54′ and the clamping cone 36.

In the next step, the machining tool 4 is clamped into the tool spindle 3. To this end, the pressure pipe 23 is pressurized by means of the hydraulic unit 21, causing the partial space 48 to be filled with the pressure medium, with the piston 45 being displaced axially in the clamping direction 38. The axial movement is supported by the at least one spring member 51. The axial movement of the piston 45 and of the actuation rod 39 causes the clamping cone 36 to be displaced in the clamping direction 38 as well, causing the clamping chucks 35 to be spread open in the usual way so as to form a back taper together with the retaining protrusion 74 for clamping the machining tool 4. The pipe 54′ is displaced in the clamping direction 38 together with the actuation rod 39. When this happens, the end wall of the tool pipe 81′ however remains in the annular space between the pipe 54′ and the clamping cone 36. The machining tool 4 is now clamped, and the supply channels 54 and 81 as well as 60 and 82 are interconnected.

In order to machine a workpiece, the spindle 25 as well as the machining tool 4 clamped therein are driven for rotation by means of the drive unit 29. The clamping unit 34, the actuation rod 39, the piston 45 and the pipe 54′ are driven for rotation together with the spindle 25. Depending on the respective cutting process and material of the workpiece 2 to be machined, the operator may choose from the following modes of operation for workpiece machining which are adjustable using the control unit 9:
In a first mode of operation, only the cooling fluid 5 is supplied to the machining tool 4. In other words, no fluid or lubricant-fluid mixture 7 is supplied at the same time. To this end, the first valve 14 is opened, and a desired flow rate Q_{K} is adjusted for the cooling fluid 5 via the flow meter 15 and the control unit 9. The second valve 19 remains closed in the first mode of operation.

The cooling fluid 5 flows from the pressure storage device 10 to the connection unit 40 via the supply pipe 44. In the region of the first connection portion 41, the cooling fluid 5 enters the inner space of the pipe 54′ via the first supply opening 56 where it flows to the discharge opening 59 arranged in the region of the clamping unit 34. At the discharge opening 59, the cooling fluid 5 enters the inner space of the tool pipe 81′ and flows through the base body 70 up to the mixing chamber 83 where no mixture takes place since no lubricant-fluid mixture 7 is provided. From the mixing chamber 83, the cooling fluid 5 flows through the distribution channels 87 to the tool discharge openings 88 where it is discharged in the region of the cutting edges 72. After being discharged from the tool discharge openings 88, the cooling fluid 5 cools the cutting edges 72 and the workpiece 2 during machining thereof.

When supplied to the tool spindle 3, the cooling fluid 5 has a temperature T_{K} of no more than 10° C., in particular of no more than 0° C., in particular of no more than −10° C., and in particular of no more than −50° C. The cooling fluid is for instance a cryogenic cooling fluid 5 and preferably has a temperature T_{K} of no more than −60° C., in particular of no more than 120° C., in particular of no more than −150° C., and in particular of no more than −180° C. The cooling fluid 5 is for instance configured as cooled air or as liquid or gaseous nitrogen. The nitrogen evaporates after exiting the machining tool 4. The cooling fluid 5 is provided at a pressure p_{K} of 1 to 5 bar above atmospheric pressure.

In a second mode of operation, only a fluid 18, in particular a lubricant-fluid mixture 7, is supplied to the machining tool 4. In other words, no cooling fluid 5 is supplied at the same time. To this end, the second valve 19 is opened, and a desired flow rate Q_{G} of the fluid 18 or the lubricant-fluid mixture 7 is adjusted via the flow meter 20. The first valve 14 remains closed. The lubricant-fluid mixture 7 is produced by the mixing device 16 from a lubricant 17 and a fluid 18 which are in each case provided at a desired ratio V_{G}. The mixing device 16 is preferably a minimum quantity mixing device which provides only a minimum required quantity of the lubricant 17 to be mixed with the fluid 18. The fluid 18 is in particular a gas, for instance air. The mixing device 16 may be operated with a quantity of the lubricant 17 amounting to zero so that only the fluid 18 is supplied. The fluid 18 or the lubricant-fluid mixture 7 is provided at a pressure p_{G} in the range of 1 to 6 bar above atmospheric pressure and at a desired temperature T_{G}. The temperature T_{G} of the fluid 18 is for instance adjustable in such a way it is reduced to a desired value, thus ensuring that the fluid 18 has a desired temperature when entering the mixing device 16.

The fluid 18 or the lubricant-fluid mixture 7 flows from the mixing device 16 through the supply pipe 64 to the connection unit 40. In the third connection portion 43, the fluid 18 or the lubricant-fluid mixture 7 radially enters the first channel portion 61 via the second supply opening 63 where it is deflected by rotation of the piston 45 acting as a deflection member, and by means of the guide channel portions 67, and is then conveyed in the axial direction. The fluid 18 or the lubricant-fluid mixture 7 then flows through the second channel portion 62 in the axial direction up to the discharge opening 68 where it enters the connection channels 86 of the second tool supply channel 82. In the machining tool 4, the fluid 18 or the lubricant-fluid mixture 7 flows at first through the connection channels 86 and then through the annular space 84 up to the mixing chamber 83. In the mixing chamber 83, no mixing takes place because no cooling fluid 5 is supplied. From the mixing chamber 83, the fluid 18 or the lubricant-fluid mixture 7 flows through the distribution channels 87 and is discharged via the tool discharge openings 88 in the region of the cutting edges 72. The lubricant-fluid mixture 7 lubricates the cutting edges 72 in the usual way and provides a limited amount of cooling to the cutting edges 72 while the fluid 18 provides a limited amount of cooling to the cutting edges 72 as well. The lubricant-fluid mixture 7 allows the tool spindle 3 to be operated with a conventional minimum quantity lubrication.

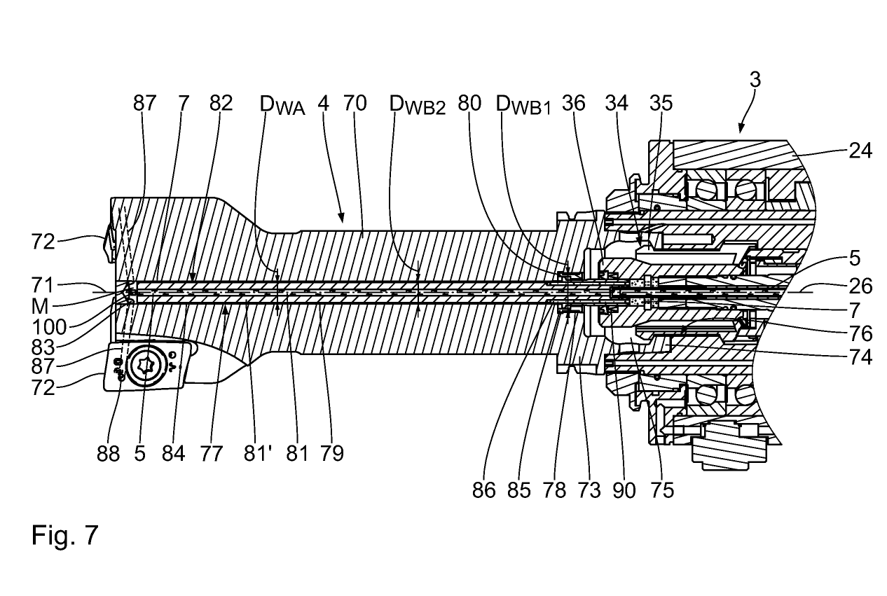

In a third mode of operation, the cooling fluid 5 and the fluid 18, in particular the lubricant-fluid mixture 7, are supplied to the machining tool 4 at the same time. To this end, the desired flow rates Q_{K} for the cooling fluid 5 and Q_{G} for the fluid 18 or the lubricant-fluid mixture 7 are adjusted via the valves 14, 19 and the associated flow meters 15, 20. The cooling fluid 5 flows to the mixing chamber 83 as described with reference to the first mode of operation. Correspondingly, the fluid 18 or the lubricant-fluid mixture 7 flows to the mixing chamber 83 as described with reference to the second mode of operation. In the mixing chamber 83, a mixture M is produced from the cooling fluid 5 and the fluid 18, in particular the lubricant-fluid mixture 7. This is illustrated in FIG. 7. The mixture M flows through the distribution channels 87 and exits the tool discharge openings 88 in the region of the cutting edges 72 where the cutting edges 72 and workpiece 2 to be machined are lubricated and/or cooled according to requirements. For cooling, the cooling fluid 5 has a temperature T_{K} when entering the tool spindle 3 which is lower than a temperature T_{G} of the fluid 18 or the lubricant-fluid mixture 7 when entering the tool spindle 3. As a result, the mixture M has a temperature T_{M} which—depending on the temperatures T_{K} and T_{G} and on the flow rates Q_{K} and Q_{G}—lies between the temperatures T_{K} and T_{G} so that T_{K}<T_{M}<T_{G}. If the cooling fluid 5 and the fluid 18, in particular a gas such as air, are supplied at the same time according to the third mode of operation, the fluid 18 allows a defined cooling effect to be obtained. The cooling fluid 5 is for instance a cryogenic cooling fluid, in particular nitrogen, and the fluid 18 is for instance air, with the result that in the third mode of operation, a defined cooling effect is achievable by means of cold air. This is in particular advantageous when machining workpieces where no lubricants 17 are allowed.

In other words, the invention provides several modes of operation which are adjustable, via the control device 9, to run individually or consecutively depending on the respective cutting process to be carried out and the respective material to be machined. This ensures an optimized workpiece machining.

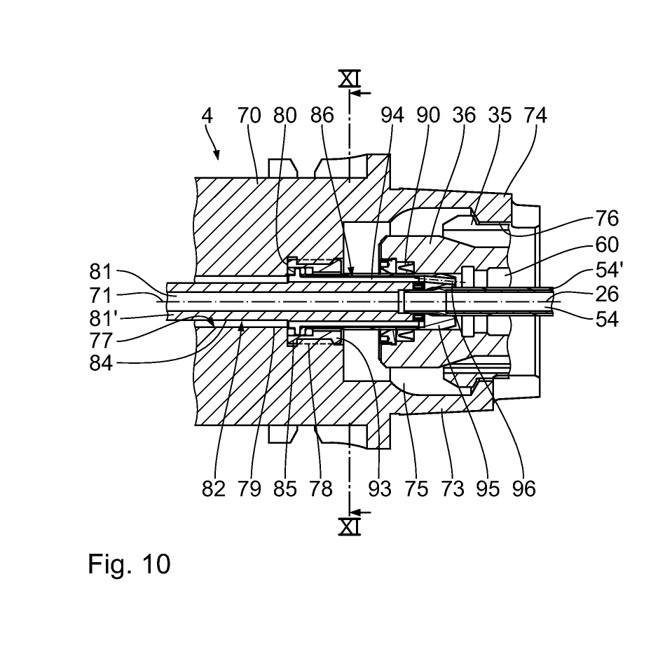

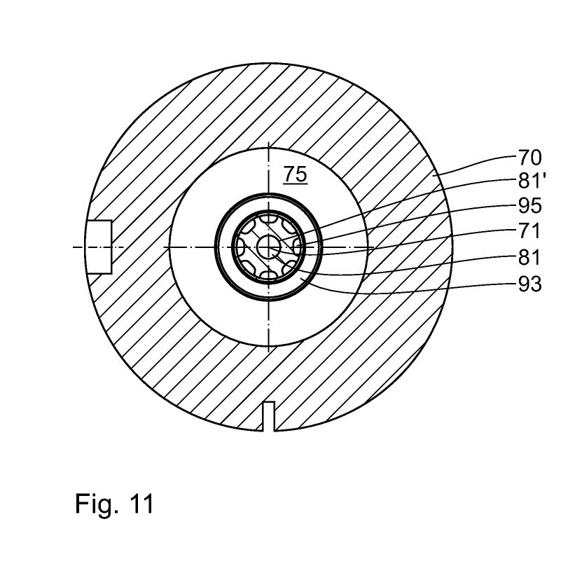

The following is a description, with reference to FIGS. 10 and 11, of a second embodiment of the invention. In the region of the receiving space 75 and the first bore portion 78, the tool pipe 81′ is provided with axial grooves 94 on its outside which are distributed around the tool axis of rotation 71 and extend in the axial direction. In the region of the axial grooves 94, the tool pipe 81′ is surrounded by a sleeve 95 which is provided with a number of sleeve channels 96 at an end facing the clamping unit 34. When the sleeve 95 is mounted, each of the sleeve channels 96 opens into a respective axial groove 94. One sleeve channel 96 forms a connection channel 86 together with a respective axial groove 94 which is bounded by the sleeve 95 in the radial direction. The axial grooves 94 increase the flow cross-section of the connection channels 86. Further details concerning the structure of the machining device 1 and the machining tool 4 and the functioning thereof are set out in the description of the preceding embodiment.

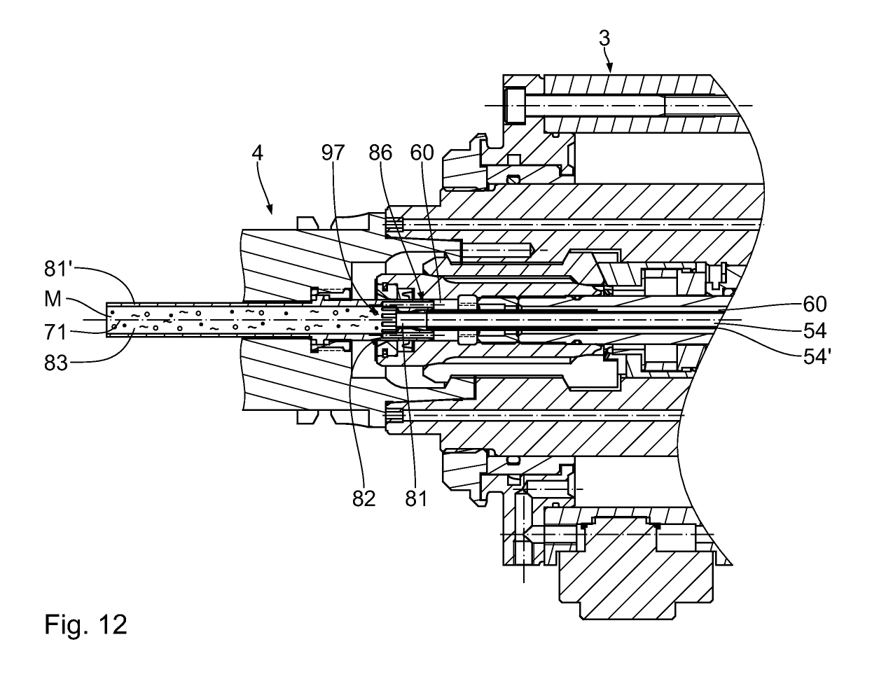

The following is a description, with reference to FIG. 12, of a third embodiment of the invention. In contrast to the preceding embodiments, the tool mixing chamber 83 is formed at a side of the machining tool 4 facing the tool spindle 3. To this end, the second supply channel 82 is only formed by the connection channels 86 which pass through the tool pipe 81′ at an end thereof so as to form discharge openings 97 leading into the first tool supply channel 81. In other words, the second tool supply channel 82 is only formed by the connection channels 86. The part of the first tool pipe 81′ arranged downstream of the discharge openings 97 thus forms the tool mixing chamber 83. The mixture produced in the mixing chamber 83 flows to the cutting edges 72 in the way already described above. Further details concerning the structure of the machining device 1 and the machining tool 4 and the functioning thereof are set out in the description of the preceding embodiments.

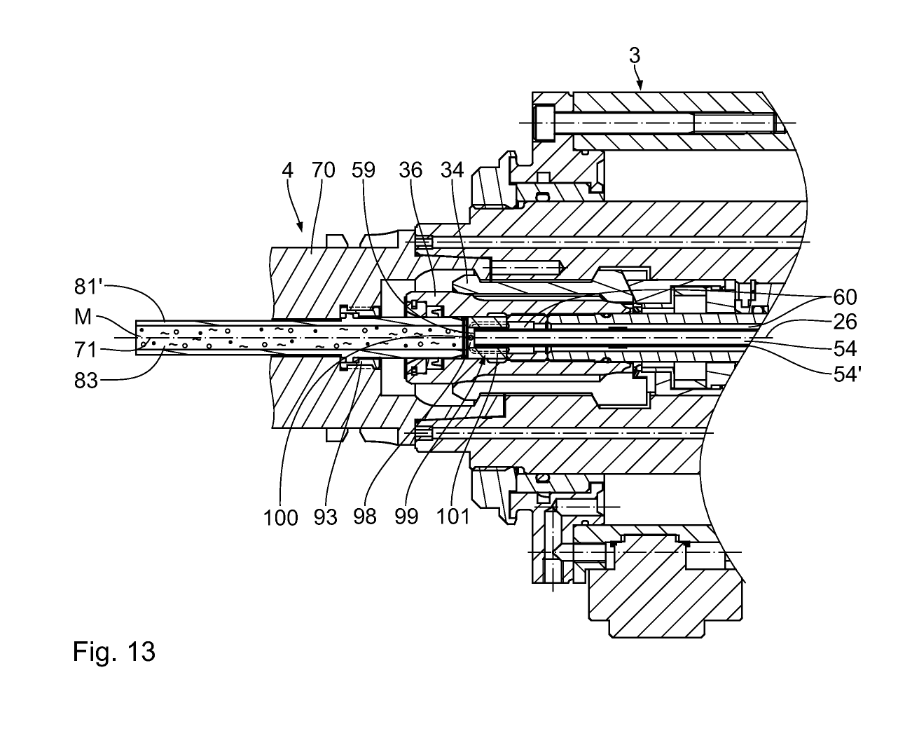

The following is a description, with reference to FIG. 13, of a third embodiment of the invention. In contrast to the preceding embodiments, the tool pipe 81′ is configured as a tool mixing chamber 83, in other words a common tool supply channel, along its entire length. The machining tool 4 is, in other words, not provided with any separate tool supply channels 81 and 82. The mixing point for the cooling fluid 5 and the fluid 18 or the lubricant-fluid mixture 7 is situated in the tool spindle 3 in the region of the clamping unit 34. The supply channels 54, 60 open into a mixing chamber 98 associated to the tool spindle 3 which mixing chamber 98 is connected to the tool mixing chamber 83 and the tool pipe 81′ when a machining tool 4 is clamped in the tool spindle 3. To this end, an end of the pipe 54′ is mounted in a mixing sleeve 99. The mixing sleeve 99 is arranged between the pipe 54′ and the clamping cone 36 and has a number of connection channels 101 which are distributed around the axis of rotation 26. The connection channels 101 connect the second channel portion 62 to the mixing chamber 98. In other words, the connection channels 101 are part of the second supply channel 60. In the mixing chamber 98, a thermometer 100 is arranged which is for instance integrated into the mixing sleeve 99. The thermometer 100 allows a temperature T_{M} of the mixture of the cooling fluid 5 and the fluid 18 or the lubricant-fluid mixture 7 to be measured and transmitted to the control unit 9 via a wireless connection. The thermometer 100 allows the flow rate Q_{K} of the cooling fluid 5 and/or the flow rate Q_{G} of the fluid 18 or the lubricant-fluid mixture 7 to be adjusted.

Due to the fact that the mixing process takes place in the tool spindle 3, the machining tool 4 has a comparatively simple design and does not require two separate tool supply channels. The underlying principle of machining tools of this type is already known. Further details concerning the structure of the machining device 1 and the machining tool 4 and the functioning thereof are set out in the description of the preceding embodiments.

What is claimed is

1. A tool spindle for machining workpieces, the tool spindle comprising:
a casing;
a drive unit allowing a machining tool to be driven for rotation; and,
a clamping unit for clamping and releasing the machining tool, wherein the clamping unit:
is arranged in the casing so as to be rotatable about an axis of rotation; and,
is drivable, by means of the drive unit, for rotation about the axis of rotation relative to the casing;
a first supply channel for supplying a cooling fluid to the machining tool; and,
a second supply channel for supplying a fluid to the machining tool.

2. A tool spindle according to claim 1, wherein the fluid is a lubricant-fluid mixture.

3. A tool spindle according to claim 1, wherein the first supply channel is formed by a pipe which is arranged concentrically with the axis of rotation and is mounted in the casing for rotation about said axis of rotation.

4. A tool spindle according to claim 1, wherein the first supply channel is formed by a thermally insulating pipe.

5. A tool spindle according to claim 1, wherein the second supply channel is at least partly annular and surrounds the first supply channel.

6. A tool spindle according to claim 1, wherein an actuation rod is coupled to the clamping unit and has an axial bore with a bore diameter D_{B} in which a pipe having an outer diameter D_{A} is arranged, wherein D_{A}<D_{B} so that the pipe forms the first supply channel and an annular space between the pipe and the actuation rod forms at least part of the second supply channel.

7. A tool spindle according to claim 1, wherein the first supply channel has a first supply opening remote from the machining tool and a first discharge opening facing the machining tool wherein the first supply opening and the first discharge opening are both arranged concentrically to the axis of rotation.

8. A tool spindle according to claim 1, wherein the second supply channel has a second supply opening remote from the machining tool which is oriented in a radial direction relative to the axis of rotation.

9. A tool spindle according to claim 8, wherein a deflection member is arranged in the second supply channel which is configured in such a way that the fluid supplied radially via the second supply opening is deflected into the axial direction.

10. A tool spindle according to claim 1, wherein the supply channels open into a mixing space.

11. A tool spindle according to claim 10, wherein the mixing space is formed in the region of the clamping unit.

12. A machining tool for a tool spindle, the machining tool comprising:
a clamping portion for interaction with a clamping unit;
a first tool supply channel for receiving the cooling fluid from a first supply channel;
a second tool supply channel for receiving the fluid from a second supply channel;
at least one cutting edge; and,
at least one tool discharge opening which is connected to the tool supply channels whereby at least one of the cooling fluid or the fluid is discharged in the region of the at least one cutting edge.

13. A machining tool according to claim 12, wherein the tool supply channels for mixing the cooling fluid with the fluid open into a tool mixing chamber; and,
wherein a number of distribution channels extend from the tool mixing chamber to a number of cutting edges.

14. A machining tool according to claim 12, wherein an axial bore is formed concentrically with a tool axis of rotation, and wherein a tool pipe is arranged therein.

15. A machining tool according to claim 12, wherein the first tool supply channel is formed by a tool pipe, and the tool pipe at least partly defines the second tool supply channel.

16. A machining device for machining workpieces, the machining device comprising:
a tool spindle;
a first provision unit for providing the cooling fluid;
a second provision unit for providing the fluid; and,
a control unit for controlling the first and second provision units.

17. A machining device according to claim 16, wherein the first provision unit comprises a pressure storage device for the cooling fluid.

18. A machining device according to claim 17, wherein the pressure storage device is at least one of insulated or coolable.

19. A machining device according to claim 16, wherein the first provision unit comprises a first valve for adjusting a flow rate of the cooling fluid.

20. A machining device according to claim 16, wherein the second provision unit comprises a mixing device for mixing a lubricant with a fluid.

21. A machining device according to claim 20, wherein the mixing device is configured as a minimum quantity mixing device.

22. A machining device according to claim 16, wherein the second provision unit comprises a second valve for adjusting a flow rate of the fluid.

23. A machining device according to claim 16, comprising at least one measuring sensor for adjusting a flow rate of at least one of the cooling fluid or the fluid.

24. A machining device according to claim 16, wherein the control unit is configured to allow selection of the following modes of operation:
a) supplying the cooling fluid to the tool spindle without supplying the fluid at the same time;
b) supplying the fluid to the tool spindle without supplying the cooling fluid at the same time; and,
c) supplying the cooling fluid and the fluid at the same time.

25. A method for machining workpieces, the method comprising the following steps:
providing a machining device, the machining device comprising a machining tool clamped in the tool spindle;
machining a workpiece by means of the machining tool; and,
simultaneously supplying a cooling fluid and a fluid via the machining tool to at least one cutting edge of the machining tool during machining of the workpiece.

26. A method according to claim 25, wherein the machining device is additionally operated in the following modes of operation:
a) supplying the cooling fluid to the tool spindle without supplying the fluid at the same time; and
b) supplying the fluid to the tool spindle without supplying the cooling fluid at the same time.

27. A method according to claim 25, wherein the cooling fluid and the fluid are mixed in front of the at least one cutting edge.

28. A method according to claim 27, wherein the cooling fluid and the fluid are mixed in at least one of the machining tool or the tool spindle.

29. A method according to claim 25, wherein when supplied to the tool spindle, the cooling fluid has a temperature T_{K} of no more than 10° C.

30. A method according to claim 25, wherein when supplied to the tool spindle, the cooling fluid has a temperature T_{K} which is lower than a temperature T_{G} of the fluid when supplied to the tool spindle.

31. A method according to claim 25, wherein a lubricant-fluid mixture is supplied to the machine tool in the form of a minimum quantity lubrication.
